(19) United States
(12) Patent Application Publication
(10) Pub. No.: US 2006/0206509 A1
(43) Pub. Date: Sep. 14, 2006

(54) Mesh compression

(76) Inventor: Michael Konstantinos Steliaros, Reading (GB)

Correspondence Address: ROBERT W. J. USHER;PATENT AGENT, 1133 BROADWAY, #1515, NEW YORK, NY, 10010, US

(21) Appl. No.: 10/483,712

(22) PCT Filed: Jul. 8, 2002
(86) PCT No.: PCT/GB02/03111

§ 371 Date: Oct. 7, 2004

(30) Foreign Application Priority Data
Jul. 9, 2001 (GB) 01167162

(51) Int. Cl. G06F 7/00

(52) U.S. Cl. 707/101

(57) ABSTRACT

A method and apparatus for transmission and reception of three dimensional image data is disclosed where vertex data, together with information on the displacement of vertices is sent for reception and reconstruction of a three dimensional object using a surface subdivision process. The method employed is characterised by all displacements for vertices of a greater magnitude being sent, received and applied before all displacements for vertices of a lesser magnitude, so that premature termination of the process results in varying degrees of surface precision, but with image integrity. The transmission and reception process employs a SPHIT Tree applied to a three dimensional object rather than to a two dimensional surface (for which SPHIT Trees were created). The SPHIT Tree also eliminates the need for a sign digit for representing the direction of displacements of vertices. Data compression and decompression is used, employing the Arithmetic Coding data compression method.

The present invention relates to the compression of three dimensional object data for efficient storage and transmission. The invention particularly relates to creation of likenesses of fine mesh wire frame surface three dimensional objects which can be “clothed” in surface textures, rendering and shading to create an image of an object of realistic appearance which can be moved by rotation, reflection and translation of the wire frame. The present invention, most particularly, relates to the creation of such a fine mesh wire frame surface by repeated application of surface division processes commencing with a starting wire frame “hull” of simple shape, the final clothed and detailed object being moved by rotation, translation, scaling or deformation of the simple starting hull.

A three dimensional object is, in this context, the infinitely thin shell described by a collection of polygons defined in three dimensional space (facets) by means of the three dimensional positional vectors at each polygon corner (vertices). Each polygon has associated hue, saturation, direction of pointing, and shading effects. The three dimensional object can be moved by translation, rotation, scaling and deformation of the entire set of vertices. There can be as much as many millions of pixels even in a simple object. Each pixel has, associated with it, many bits of data defining its position (to a high degree of precision) in space. Furthermore each facet has associated with it, many bits of data defining the vertices that constitute its shape, and its visual properties such as hue, saturation, reflectivity etc. Three dimensional visual objects are very data intensive.

A problem arises when three dimensional objects are transmitted, for example, on the Internet or to a cellular telephone, or stored on a disc or other memory device. Many megabytes of data take a long time to transmit or occupy a lot of capacity. At the standard Internet speed of 14.4 Kb/s it takes just over nine minutes to download a one megabyte visual object. At the slower signalling speeds of cellular telephones, it takes proportionally even longer. Such delays are unacceptable.

Another problem arises when it is desired to manipulate the view of a three dimensional visual object. With conventional two dimensional display devices, visualisation is achieved through projection of the three dimensional data onto the two dimensional display. The receiving device is required to calculate very large amounts of positional data (at least one set of calculations for each vertex) before the manipulated image is in a suitable state to be viewed. Further difficulties arise, since a “scene” might be made up of many separate three dimensional objects. The calculations have to be made for each object which experiences movement or rotation relative to the viewpoint. Altogether, it can be said that complex three dimensional visual objects of certain degree of realism are not suitable for fast transmission or subsequent change of orientation in present day equipment.

To avoid the problem of still being required to transmit data defining the position of each of the surface vertices, a reduction technique is employed. A simplified shape, having only a few vertices, is found. Positional details of the very few vertices of the simplified shape are transmitted. The simplified shape is used in conjunction with a surface division algorithm at the receiving end. Each of the polygons defining the simplified shape is processed (divided) in a surface division process to generate connected but smaller polygons. The process is re-applied to the new polygons, and so on until an adequate fineness of detail (resolution and/or surface smoothness) has been achieved.

An example of the power of such a technique is seen in the example of a sphere. A very high definition sphere can be defined in space and dimensions starting with a simplified object (known as a hull) such as a tetrahedron (four vertices giving four triangular faces). In general, the hull should be homomorphic (having the same properties of edge connectivity and surface continuity) with the final object. A tetrahedron has a continuous single surface with no terminating edge. It is therefore homomorphic with a sphere.

Very simple hulls can produce only a very limited repertoire of final objects. To achieve high realism with complex objects one would have to employ a more complex initial hull. To augment the technique, positional correction of vertices has been employed. At each stage of the division algorithm, each new vertex, created by dividing a line joining two existing vertices on the surface, can be moved (displaced) to new position relative to its position as defined by the raw algorithm. The displacement is transmitted, to be applied to a particular newly created vertex at a particular stage of application of the algorithm (division), along with details of the hull. At the particular stage of application of the algorithm, the selected vertex is displaced by the selected amount. Subsequent application of the algorithm is carried out using the new (displaced) position for that vertex. Moving a vertex at a particular stage of using the surface division algorithm thus affects the position of all subsequent new vertices whose position is a function of the position of the selected vertex. Since only newly created vertices can be moved (at the instant of or immediately after their creation), there is still a limitation as to the different shapes that can be created, or the economy of signalling required to achieve a particular shape. The present invention seeks to provide improvement over these shortcomings.

In order to keep the integrity of the relationship between the various points which make up the object, it is usual to define the displacement of the selected vertex relative to the polygon to which the selected vertex is assigned rather than in an origin based Cartesian co-ordinate system. The plane of the associated polygon or polygons is used to define a normal direction for the selected vertex. The displacement is defined in terms of the normal direction and two orthogonal tangential directions.

An edge subdivision method, such as discussed above, is described in United Kingdom Patent Application 9926131.5 “Image Enhancement” filed 5 Nov. 1999 by the same applicants, in which the position of a new vertex is not necessarily in the centre of an edge, but depends on the quality (visible, invisible, smooth etc) to be imparted to edges and vertices in the representation of the final object.

A problem arises with the system described above. In order to create a surface feature, it is often necessary to create a large number of displacements at consecutive levels of fineness (consecutive applications of the surface division algorithm). The present invention seeks to provide a method and means for reducing the number of displacements required for fine surface detail.

There are two general approaches to three dimensional image creation. The first approach is analytic. A three dimensional scan of an actual object is obtained. A reduction algorithm (essentially the opposite of the surface division process) is then applied to find the simplest hull that can be used to reconstruct the object. The second approach is constructional. A hull is postulated, and corrections applied to the resulting stages of surface division to produce an object which is acceptably close to the desired object. Modifications to the hull and the displacements are made until acceptability is achieved. The present invention seeks to provide improvement and added utility in the second (constructional) method, although it is also applicable to the results of the analytic process.

The transmission, even of the simplified data required for reconstructing an object by the hull division and vertex displacement method, can be slower than desirable and subject to problems resulting from imperfect transmission. To overcome these problems, various coding techniques have been employed.

One problem is loss of significant local detail if a message is truncated. To overcome this, Amir Said and William A. Pearlman, in 1996 presented to the IEEE a paper “A New, Fast and Efficient Image Codec Based on Set Partitioning in Hierarchical Trees” (IEEE Trans on Circuits and Systems for Video Technology 6(3): pages 243-250 1996) providing the Set Partitioning In Hierarchical Trees (SPHIT) method. The paper related to two dimensional flat images (pictures) This paper is incorporated into this application by reference.

In the Said Pearlman method, the co-ordinates of a pixel are mapped by a “unitary hierarchical subband transformation” to a pyramid of coefficients corresponding to the transformation subbands; the number of coefficients being the same as the number of pixels in the original image. The array of coefficients is then used in a progressive transmission scheme.

The contents of the array are ranked according to their binary magnitude. All the coefficients with most significant bit (MSB) set to one are ranked first (and thereafter in decreasing order of magnitude). All the coefficients with the second most significant bit set to one, but the most significant bit set to zero, are ranked next, also thereafter in decreasing order of magnitude. This process is repeated until all of the coefficients are ranked in order, from the largest magnitude to the lowest magnitude. The coefficients with each bit (from the most significant bit to the least significant bit (LSB)) set to one, but the next most significant bit set to zero, are counted to give a bit count number for each binary digit. This is continued until the least significant bit (LSB) has been assigned its bit count number. The sign of each coefficient is appended, in the ranked order.

In transmission, the maximum number of bits (binary digits) required to express the coordinates is first sent to the decoder. Then, a “Sorting Pass” sends the bit count number for the current (in this case, the most significant) bit, the co-ordinates of all of the pixels referred to by the coefficients having the current (in this case, the most significant) bit set to one, and the sign of all of the coefficients, ranked in order of magnitude descent, having the current (in this case, the most significant) bit set to one. This terminates the “Sorting Pass” for the current (most significant) bit.

Next, a “Refinement Pass” transmits the current (in this case, the most significant) bit for each of the coefficients which has been the subject of this or a previous a sorting pass, in the same order that was used to send the co-ordinates of the pixels. This terminates the “Refinement Pass”

Thereafter, the next most significant bit is chosen as the current significant bit and a “sorting Pass” followed by a “Refinement Pass” is executed. This is continued either until the least significant bit (LSB) has been sorted and refined, or until an acceptable degree of distortion (deviation from the desired image) has been achieved, whichever happens sooner.

Because the most significant coefficients are transmitted first, and have their most significant binary digits transmitted first, the likeness of the picture can be transmitted and suffer least degradation (deviation from the desired image) if the transmission is prematurely terminated (as may happen in a heavy traffic environment). The larger coefficients have the greatest impact on the overall appearance of the picture. Their most significant bits (MSB) have the largest impact of all. By transmitting them first, the main structure of the picture is established first. The coefficients of lesser magnitude have lesser impact on the appearance of the picture. They, too, are transmitted with their more significant bits first. Thus, if the transmission is terminated at any stage, the most significant coefficients, and their most significant binary digits have been transmitted, and all lesser coefficients, more significant bits first in descending order of magnitude, up to that stage. The overall result is that the general structure of the picture is entire, and simply lacks a degree of fineness of detail which would have been provided had the transmission continued. The longer the transmission continues, the more detail is added to the coefficients and by consequence of the inverse of the “unitary hierarchical subband transformation” mentioned earlier, to the detail of the picture. The shorter the transmission, the coarser the detail of the picture becomes, but it still is an entire picture.

Amir Said and William A. Pearlman, in the same paper, also proposed the incorporation of a “Set Partitioning Sorting Algorithm”. In this algorithm, if a coefficient has an nth or higher bit set to one, it is said to be significant at level n. If a coefficient has no nth or higher bit set to one, it is said to be insignificant at level n.

The sorting algorithm divides the pixels into partitioned subsets. The pixel whose coefficient has maximum size in each subset has its coefficient tested to see if it is significant or insignificant at level n.

If the largest coefficient associated with the subset is insignificant, then all of the pixels in that subset have insignificant coefficients.

If the largest coefficient in the subset is significant at level n, none, some or all of the other coefficients associated with that subset may also be significant at level n. The subset is divided, according to a rule known in common by the transmitting encoder and the receiving decoder, into smaller secondary subsets, and the same test applied to each of the secondary subsets. This test and subdivide process is continued on the secondary and subsequent subsets until all single element (single coefficient) subsets having a significant coefficient at level n have been identified. The process is carried out for all values of n, from the most significant bit (MSB) to the least significant bit (LSB). In this way, the coefficients are implicitly sorted into all those having magnitude greater than or equal to the nth power of two, where n is the number of a bit in the representation of the magnitude of the coefficient. It is possible to say that the coefficients are sorted by size. Each sorting category represents a size increase by a factor of two. If the coefficient is bigger than the category maximum, it is included in the category. If the coefficient is smaller than the category maximum, it is omitted from the category.

The method also proposes the use of a “Spatial Orientation Tree”. The process of splitting subsets when the largest coefficient associated with a pixel in that subset has been found to be significant at level n is based on the concept of a “parent” coefficient and an “offspring” coefficient. At each stage of operation of the division algorithm, each existing coefficient (the parent) spawns four further coefficients (the offspring)(except at the final stage). The initial partition is formed using all offspring, and their offspring (the totality of descendants) of each root pixel. If the set of all descendants is found to be significant, it is partitioned into a subset of immediate offspring, and a subset of grandchildren and beyond. If the subset of grandchildren and beyond is found to be significant, it is partitioned into four subsets each comprising the descendants of each of the immediate offspring of the original root pixel. In this way the subset creation “crawls up” the tree from the root to the very tips of the twigs, maintaining the same division strategy at each new level. The reason for employing such a hierarchy is that the SPIHT algorithm can exploit the fact that if a coefficient is NOT significant and none of its children are significant then the entire tree can be skipped.

The results of significance testing are stored in three ordered lists. These are the List of Insignificant Sets (LIS), the List of Insignificant Pixels (LIP), and the List of Significant Pixels (LSP). In the LIS, the subsets are differentiated according to whether they contain all descendants of a root pixel, or whether they contain only grandchildren or beyond of the root pixel. During the sorting pass, the pixels in the LIP which were insignificant in the previous pass, are tested, and if they are found to be significant, are moved to the LSP. The subsets in the LIS are similarly tested. Any that are found significant are removed from the LIS and partitioned. New subsets, derived from the partitioning, with more than one element, are returned to the LIS. Single element subsets, derived from the partitioning, are added to the LIP, or to the LSP, depending on whether or not they are significant. The LSP contains the vertices which are visited in the refinement pass. The present invention seeks to utilise this technique, in a modified and improved form, and in a new area of three dimensional images.

The present invention also seeks to provide a novel application for a code compression technique, disclosed in a paper titled “Arithmetic Coding for Data Compression” by Witten, Neal & Clearly in the Communications of the ACM in June 1987, which paper is also incorporated, by reference.

According to a first aspect, the present invention comprises an apparatus for transmission of vertex displacement information for use in reconstructing a three dimensional surface by surface subdivision; said apparatus comprising means to define the coordinates of a vertex in terms of its occurrence in the surface subdivision process, and means to transmit more significant elements of the displacements before lesser elements of the displacements.

The invention also provides an apparatus wherein the displacements are defined as binary numbers, and wherein the more significant elements are binary digits of greater significance.

The invention also provides an apparatus including: means to select the displacements in descending order of magnitude; means to select each significant binary digit, used to represent the displacements, in descending order of significance; means to send, in order of magnitude of the respective displacements, the total number and the co-ordinates of each vertex whose displacement has a most significant digit equal to the selected significant binary digit; and means to send the selected significant bits in the representation of the displacement, in descending order of the magnitude of the respective displacement, for each vertex which has previously been found to have a most significant digit equal to a previously selected significant binary digit.

The invention also provides an apparatus comprising a data compressor, for preference an Arithmetic Coding data compressor.

According to another aspect, the present invention provides a surface subdivision means wherein any vertex can be displaced.

According to a further aspect, the present invention provides the use of SPHIT Tree encoding for a three dimensional object as opposed to a two dimensional surface.

According to further aspects, the present invention consists in receiving and reconstruction apparatus for use with all provisions of the invention.

According to a further aspect, the present invention consists in a method, consistent with all other provisions of the invention.

The invention is further described, by way of example, by the following description, taken in conjunction with the appended drawings, in which:

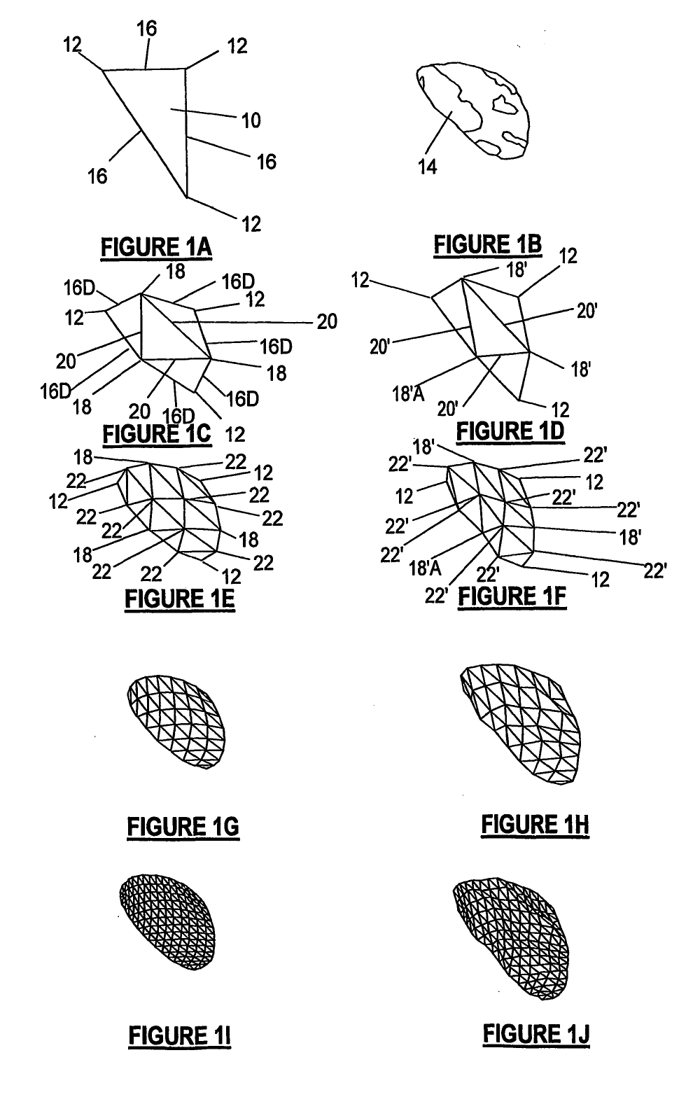

FIGS. 1A to 1J are a diagramatic representation of the mesh division process used in the preferred embodiment of the present invention.

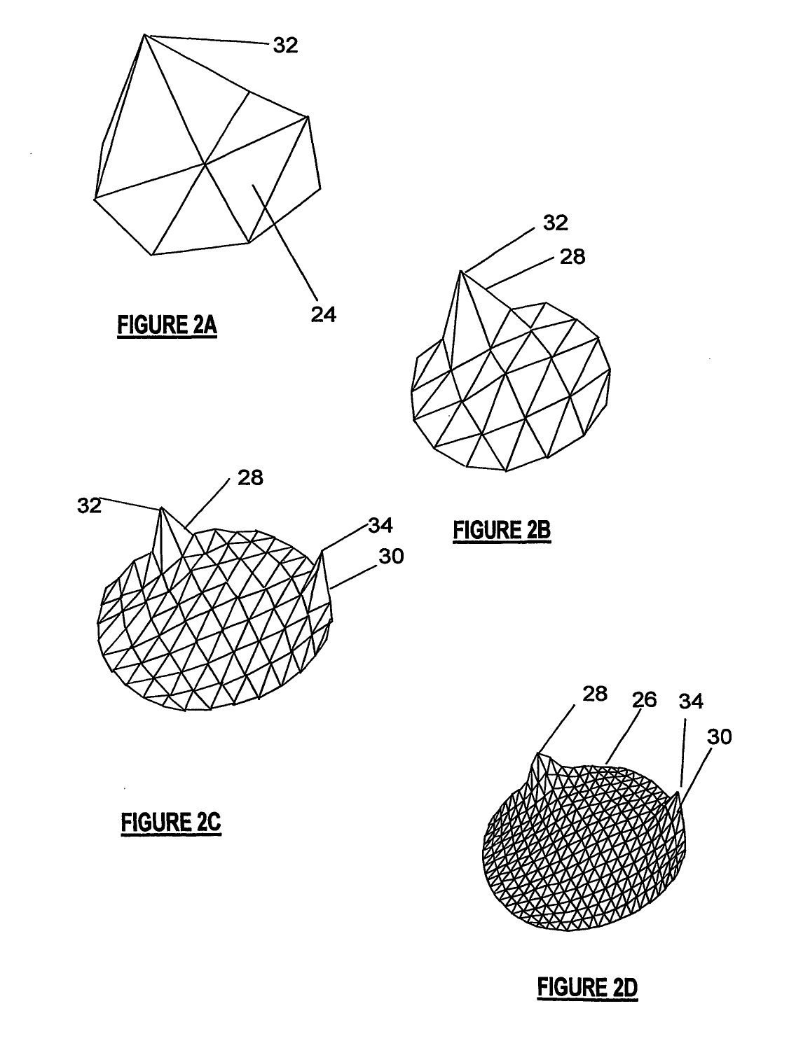

FIGS. 2A to 2D compare prior art displacement methods with the method provided by the present invention.

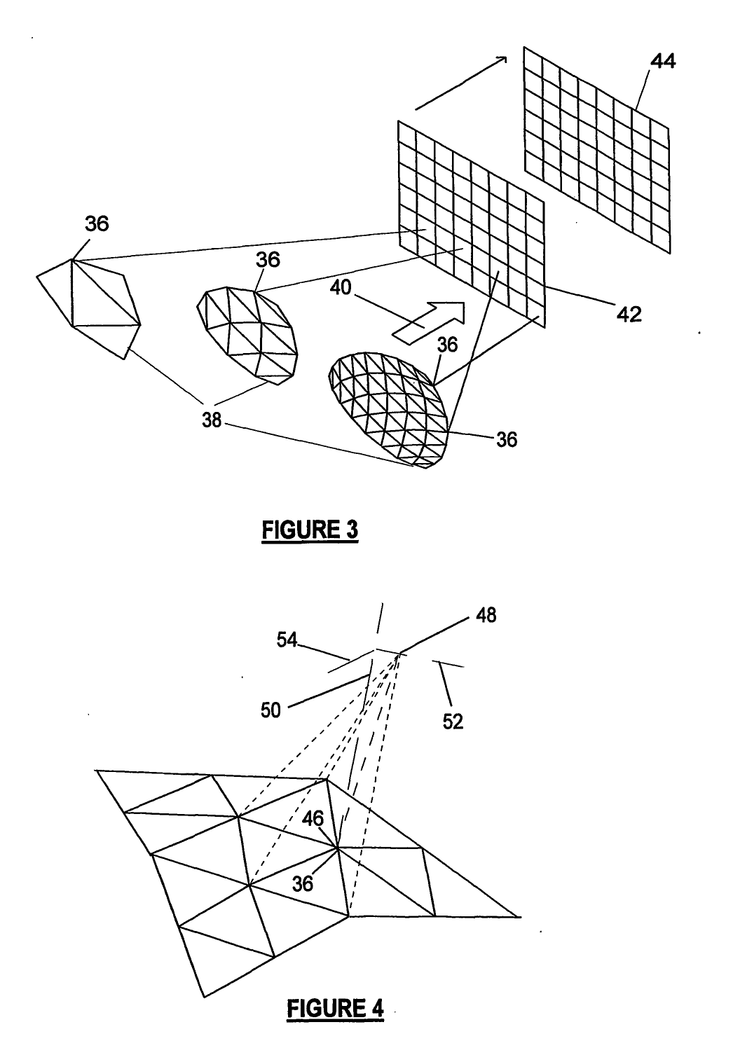

FIG. 3 is represents the first stage of the encoding of mesh data for transmission, sending or storage.

FIG. 4 illustrates what is meant by a vertex displacement.

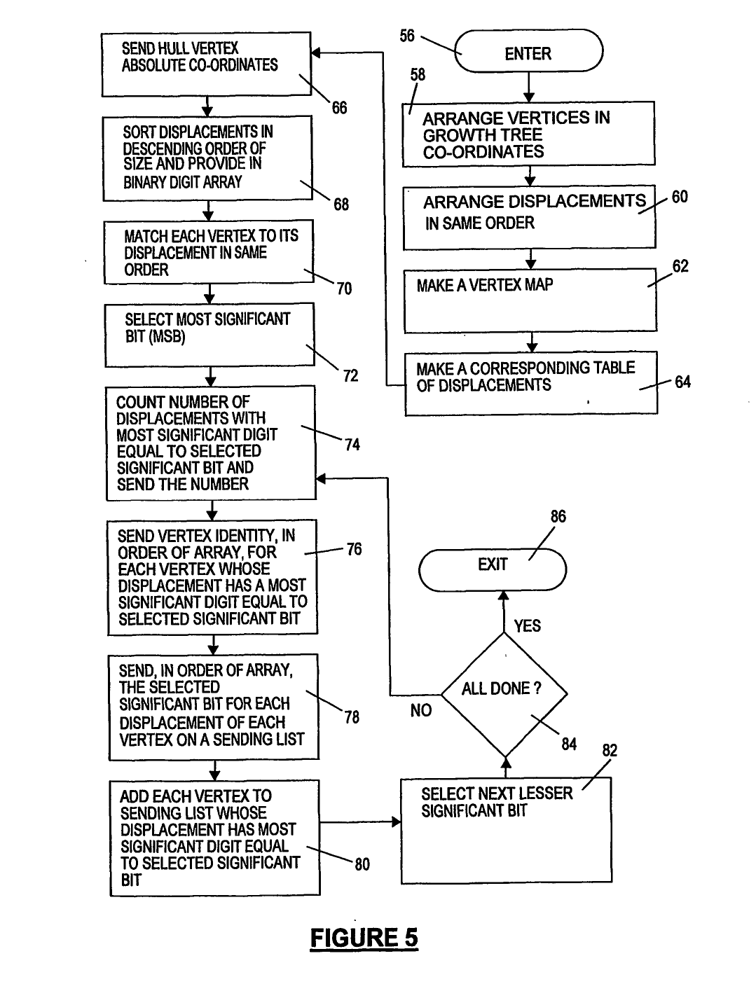

FIG. 5 is a flow chart showing the full mesh encoding method of the present invention.

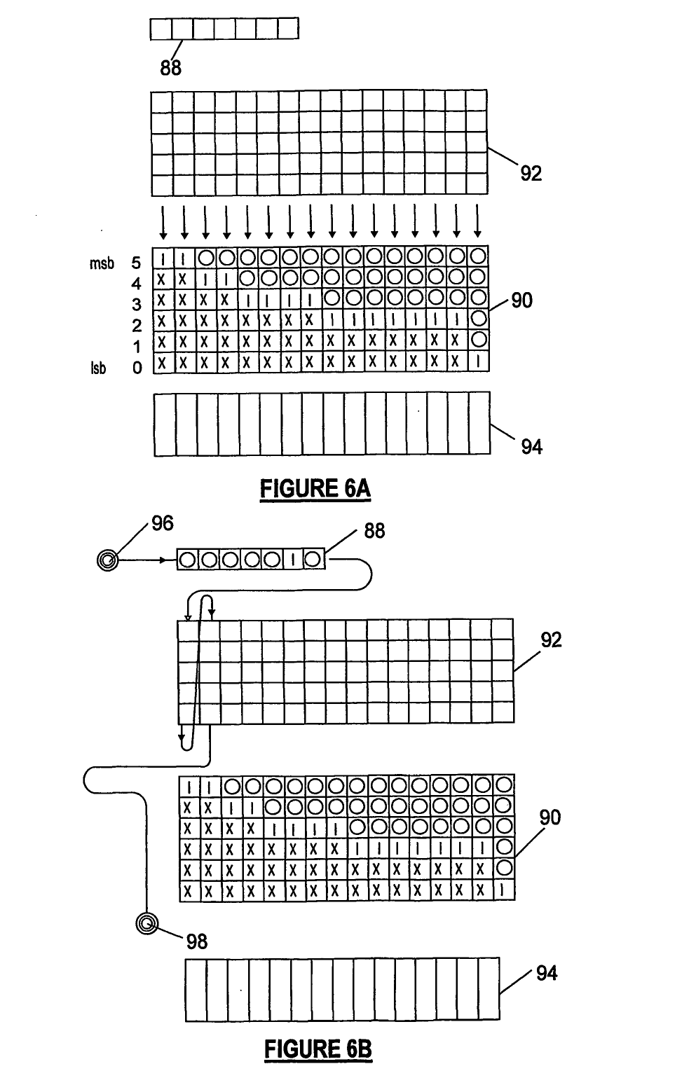

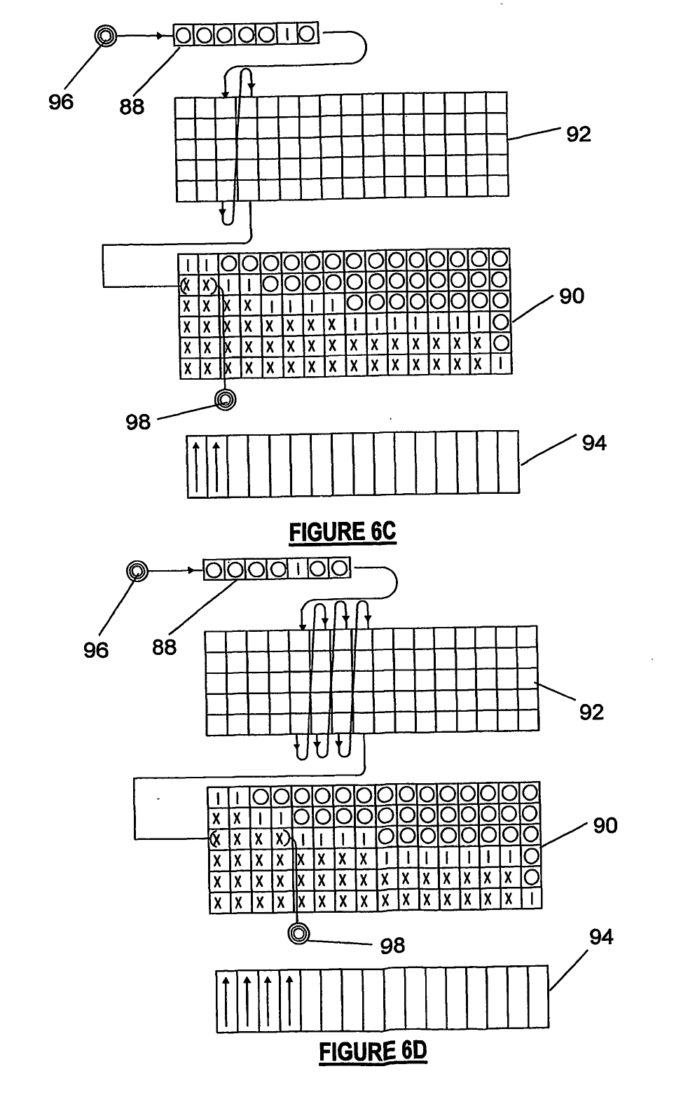

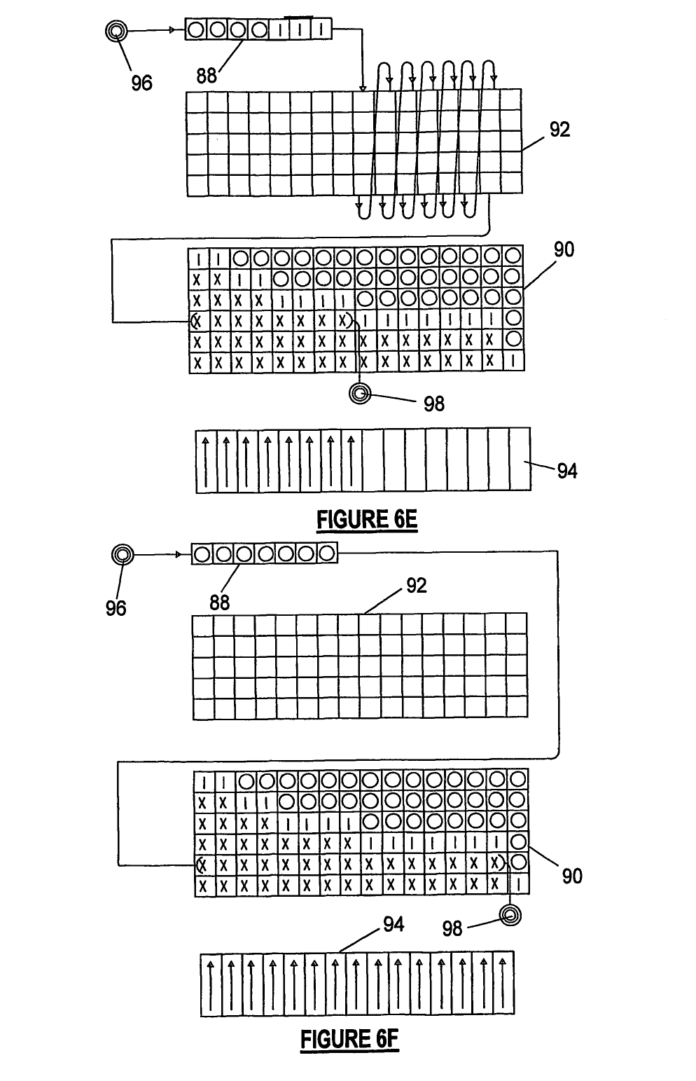

FIGS. 6A to 6F show, in schematic and further explanatory manner, the encoding method otherwise provided in FIG. 5 and

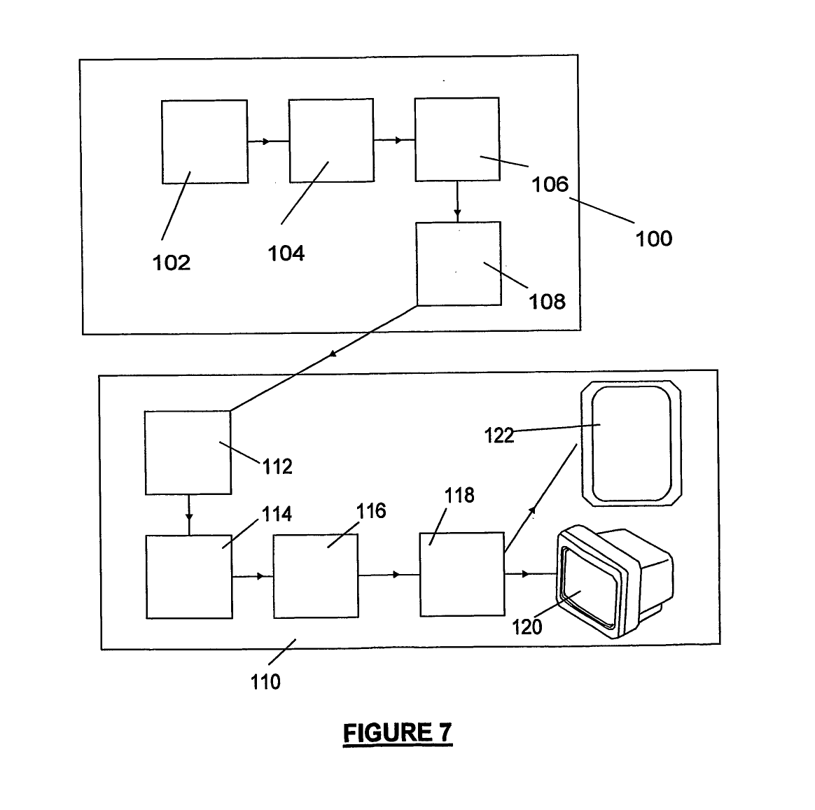

FIG. 7 is a schematic block diagram of one environment where the present invention, including data compression and decompression, can be employed.

Attention is drawn to FIGS. 1A to 1J, showing various stages in a loop edge subdivision routine, suitable for use in the preferred embodiment of the present invention. In general terms, starting with an initial triangular hull 10, shown in FIG. 1A, the hull 10 having three initial vertices 12, progressive stages of an edge division process are shown, the left hand column comprising FIGS. 1C, 1E, 1G and 1I having the essential edge division and movement process, while the right hand column, comprising FIGS. 1D, 1F, 1H and 1J shows a similar process to that shown in the left hand column, but with an added random noise component added to the displacement. FIG. 1B shows a line drawing of the final target object 14, in this instance being in the form of a rock. Vertices 12 are displaced from their created positions to form the final shape of the target object 14.

In greater detail, turning to FIGS. 1A and 1B, initial edges 16 are subdivided, in accordance with the Loop algorithm, to form vertices 18 on divided initial edges 16D to create the first stage form shown in FIG. 1B. The first stage form, shown in FIG. 1D, is derived in the same way, except that some random noise is added to the displacements of the first stage vertices 18 to create noisy first stage vertices 18′. First stage edges 20′ are created by joining the first stage vertices 18 and the noisy first stage vertices 18′.

Having executed one subdivision process, the first stage, a further subdivision process is applied, the second stage. The results of this are shown in FIGS. 1E and 1F. Every first stage edge 18 and every divided initial edge 16D is again split in two to form second stage vertices 22 which are positioned in accordance with the Loop algorithm to provide the form shown in FIG. 1E. Similarly, every first stage edge 18′ and every divided initial edge 16D′ is again split in two to form second stage vertices 22′ which are displaced from their initial point of creation, defined by the Loop algorithm, through addition of random noise to provide the form shown in FIG. 1F. The detail is too small properly to be shown with indicator lines and numerals.

Of particular interest to the present invention is first stage moved vertex 18′A shown in FIG. 1F. Although its counterpart is shown in FIG. 1E un-displaced in the second stage, compared to FIG. 1C,in the situation of FIG. 1D, the first stage moved vertex 18′A is moved between the first stage of FIG. 1D and the second stage of FIG. 1F.

In the present invention, essentially any vertex can be moved at any stage of the division process. Each new vertex is created and displaced on the basis of the positions of the existing vertices created or pre-existing at the previous stage of the division process. A newly created vertex may or may not be displaced at all.

If it is to be displaced, it may be displaced at the stage of division where it is created, or it may be displaced at a later stage. The time of displacement entirely depends on the size of the displacement. This will become clear from the following description. The position of subsequent vertices, dependent upon the position of a newly created vertex, is determined by the newly created vertex un-displaced until the newly created vertex is eventually displaced. Here lies an essential difference between the present invention and all other methods employing multiple division to create new displaceable vertices.

The subdivision process passes through further stages, to create the forms of FIGS. 1G and 1I and the forms of FIGS. 1H and 1J. The subdivision process is continued until an acceptable degree of detail in the wire-mesh form has been achieved. This is entirely decided by the application in which the target object 14 is to be used. A low resolution application has few stages. A high resolution application has many stages.

The present invention is shown, in its preferred embodiment, using a triangular polygon division process, since this is the simplest form of polygon. It is to be appreciated that the present invention can be applied to any subdivision process where new displaceable vertices are created from old vertices, using any shape of polygon.

Attention is drawn to FIGS. 2A to 2C, showing how a surface feature can be formed, employing the new invention, and in comparison to the prior art methods. A three dimensional hull 24 is to produce a final object 26. The final object 26 has a first spike 28 and a second spike 30. A start vertex 32 is progressively modified, according to the prior art, by moving only new vertices, to form the rather unsatisfactory (un-spikey) shape of the first spike 26 shown in FIG. 2D. The prior art takes fifteen displacements of newly created vertices to reach its somewhat unsatisfactory shape. By comparison, the second spike 30 is formed by the single displacement of a moved pre-existing vertex (according to the present invention) (it need not have been pre-existing) two stages of division after the three dimensional hull 24. This is the only displacement required, in this example, to produce the much more satisfactory shape of the second spike 30.

Attention is drawn to FIG. 3, being a conceptual schematic diagram of the manner in which the present invention prepares a final object for transmission.

Every vertex 36 on the intermediate and final objects 38 is mapped, as indicated by arrow 40 onto a vertex map 42. The position, on the vertex map 42, is decided by, at what stage of division, the particular final vertex 36 came into existence. For example, a final vertex 36 on the original hull would have an entry in the position for the zero'th stage entries. In the example given, each final 38 vertex created at the first division would have an entry on the vertex map for first stage entries. In each division stage, four new final vertices 36 are created for each final vertex 36 pre-existing that stage. The newly created vertices at each stage are identified in a preferred, predetermined order, which is the choice of the designer. In this way a “tree” of identification of a particular final vertex 36 is created, depending upon its “ancestor” vertices, each “child” becoming an “ancestor” at the next stage of division. The position on the tree determines the position of the final vertex 36 on the vertex map 42. Each original vertex 12, in the hull 10, 24, creates its own tree. The original vertices 12 also are ordered in the vertex table. By referring to a particular position in the vertex table 42, it is possible to know from which original vertex 12 a final vertex 36 is derived and at what stage of the division process the final vertex 36 appears.

The vertex table is not a real entity, it is merely a set of ordered addresses, each identifying a particular final vertex 36. Unlike the Sphit tree, the final vertices in a three dimensional final object 38 are identified, rather than the individual pixels in a two dimensional image. The vertex map is used as the addresses to identify the associated final vertex for a displacement table 44. The displacement table 44 stores, in the position appropriate to a particular final vertex 36, the displacement to be given to that vertex 36. The present invention, thereby, succeeds in creating implicit addressing for vertices in a three dimensional final object 38.

Attention is drawn to FIG. 4, showing what is meant by a displacement, in the preferred embodiment of the invention. A selected vertex 36 is to be displaced from the rest position 46 where it was found to be prior to displacement, to a displaced position 48. In the example shown, a normal 50 to the vertex 36 is drawn in accordance with the rules used for the particular division method. The direction of the normal can depend upon the planes occupied by the surrounding polygons (triangles, in this case). The displacement is determined by the displacement along the normal 50, together with displacements along two orthogonal tangential directions 52, 54. In the example shown, a number of binary digits are used to express the size of each component of displacement. It has been found that the perceived quality of a final object 38 is far more sensitive to displacements along the normal 38 than to displacements along the tangential directions 52 54. Accordingly, in this example, twelve bits are allocated to express the normal displacement and only ten each for the tangential displacements. This is not important for the invention. The invention can be used with any number of bits for any displacement. The invention can also be used with other systems of expression of the displacement, such as, but not limited by, polar co-ordinates (angles and radius).

Attention is next drawn to FIG. 5, showing a flow chart of the notional activity of the present invention when preparing and transmitting the likeness of a three dimensional final object 38 employing the simple sorting algorithm described as an introduction in the Said Pearlman method. In an actual application a more efficient compression algorithm would be employed, such as, but not limited by, the Set Partitioning scheme of Said and Pearlman.

From entry 56 a first operation 58 the final vertices 36 have their growth tree position determined. A second operation 60 pairs up the displacements with their corresponding final vertices 36. A third operation 62 sorts the growth tree positions into the vertex map 42, and a fourth operation 64 constructs the displacement table 44. Everything is now ready to prepare to transmit the likeness of the final object 38.

A fifth operation 66 first transmits the absolute spatial coordinates of each of the initial vertices 12 on the hull 14, 24. This is necessary so that the receiving device, which functions in the exact inverse manner to the transmitting device, can reconstruct the likeness of the final object 38.

The displacements are then sorted, in a sixth operation 68, in descending order of size. This can be determined by the choice of the designer. For example, they may sorted by descending size of the normal displacement. Alternatively, they may be sorted by the absolute length of the vector created by the vector sum of the normal and tangential components. In a polar co-ordinate system, the displacements can be sorted by the length of the radius. The present invention prefers, but does not insist upon, the sorting in descending order of magnitude being for that element of the displacement which has most significant impact on the final representation of the final object 38. In any event, a series of binary numbers are produced with all of the displacements with the most significant bits set at one together in descending order, all of the displacement with the most significant bit at zero, but the next most significant bit set to one, in descending order, and so on, in a binary digit array.

A seventh operation 70 then matches up the respective final vertex 36 corresponding to each displacement in the binary digit array. This can be done by knowing the address of the displacement in the displacement table 44. All is now ready to start sending the displacement data.

An eighth operation 72 selects the most significant bit of the displacements listed in the binary digit array. A ninth operation 74 then counts the number of displacements having their most significant digit (the highest value binary digit in their representation) equal to the selected significant bit (on this occasion the most significant bit). That number is then transmitted. This represents the number of final vertices who have the selected significant bit as their most significant digit. There is therefore no need to send the “one” for each final vertex 36 in that category, since the number of “ones” is “known” A tenth operation sends the identity of each final vertex 36 with the most significant digit equal to the selected significant bit. This is simply the co-ordinates of the vertex in the vertex map 42, being the address of the displacement.

An eleventh operation 78 then consults a vertex sending list. This is a list, in the same order as the binary digit array, of all those final vertices 36 that have previously been found to have their most significant digit equal to the selected significant bit. In this, the first pass, where the most significant bit is selected, the vertex sending list, is, of course, empty. If there were entries in the vertex sending list (as will happen on subsequent passes), the selected significant bit for all of the displacements of vertices 36 listed in the vertex sending list, is transmitted, in the same order as they appear on the on the binary digit array.

A twelfth operation 80 then adds, to the vertex sending list, in the same order as they appear on the binary digit array, all of the vertices which have been found to have their most significant digit equal to the selected significant bit. That way, when the selected significant bit has been changed to the next lesser significant bit in a thirteenth operation 82, they, too, on the next pass, will have their next less significant bit transmitted in the order of the binary digit array.

A first test 84 then checks to see if the routine has reached and operated upon the least significant bit. If it has, the routine moves to exit 86. If it has not, control passes back to the ninth operation 74.

The routine keeps looping until all of the binary digits in the displacements of all of the final vertices 36 has been sent. Once again, there is no need to send the details on those final vertices which have no displacement, since the total number of final vertices 36 is known from the number of initial vertices 12 in the hull 10, 24 and the number of stages of division undergone from the initial hull 10, 24.

In order to improve clarity concerning the flowchart of FIG. 5, FIGS. 6A to 6D show a schematic representation of the same activity.

A bit number register 88 is provided for acquiring and sending the number of displacements with their most significant digit equal to the selected significant bit (in accordance with the ninth operation 74 of FIG. 5).

A binary digit array 90 holds the displacements (in accordance with the sixth operation 68 of FIG. 5) in descending order of size. Exemplary entries are shown. The 1 indicates a binary one. The 0 indicates a binary zero. The X indicates any binary digit, being part of the binary number representing the size of the individual displacement. A moment's reflection, and consideration of the following description, will show that the 1's and the 1's must be arranged in blocks as shown.

A vertex address register 92 stores the addresses of the vertices 36 which correspond to the displacements immediately therebelow. This is in accordance with the seventh operation 70 of FIG. 5. The address of each vertex 36 is simply its point of appearance on the growth tree, and is exemplified by the vertex map 42 of FIG. 3.

A vertex sending list 94 stores the identity of each vertex 36 which has previously been processed. This is in accordance with the eleventh 78 and twelfth 80 operations of FIG. 5, and its meaning and use will become clear from the following description.

The Binary digit array 90, as shown in this example, has, for the sake of clarity and brevity, only six significant bits, starting with bit 5, the most significant bit (MSB) and descending, in order, to bit 0, the least significant bit (LSB). It is to be appreciated that, in real life, there would be much more than six significant bits and many more entries than the sixteen shown.

Attention is now drawn to FIG. 6B, showing the sending sequence when the most significant bit (MSB, bit 5) is selected, in accordance with the eighth operation 72 of FIG. 5.

From a data start 96, the contents of the bit number register 88 are sent. Examination of the binary digit array shows that there are two 1's in the bit 5 row. The number in the bit number register is therefore binary 2 (0000010).

The contents of the bit number register 88 having been sent, the sending sequence moves on to the vertex address register 92, where the addresses of the two vertices 36, whose displacements have a 1 in the bit 5 row of the binary digit array, are sent in the order their displacements appear in the binary digit array 90.

At this stage, the sending sequence consults the vertex sending list 94, to see if it has any entries. This accords to the eleventh operation 78 of FIG. 5. Since the MSB (bit 5) is currently selected, there are no entries in the vertex sending list 94, which is empty. No further data are sent, and the sending list moves to a data end 98.

Attention is drawn to FIG. 6C, showing the second stage of the sending sequence.

In accordance with the twelfth operation 80 of FIG. 5, the MSB (bit 5) sending sequence having been executed, the two vertices 36 with having a 1 in the bit 5 row have been added to the vertex sending list. In accordance with the thirteenth operation 82 of FIG. 5, bit 4 (the next lesser significant bit) has been selected. There are two 1's in the bit 4 row, so the content of the bit number register 88 is, once again, binary two (0000010). The sending sequence first sends the contents of the bit number register 88, and then sends, in the order their displacements appear in the binary digit array, the identities of the vertices 36 whose displacements have a 1 in the bit 4 row and a zero in every higher row (that is to say, their most significant digit is in the bit 4 row). At this stage, the sending sequence consults the vertex sending list 94. There are two entries, one for each of the vertices whose displacements had their most significant digit in the bit 5 row. The sending sequence therefore sends the bit 4 row data bits (X), in the order they appear in the binary digit array 92, for the two vertices listed in the vertex sending list 94. This terminates 98 the sending sequence for bit 4. At this stage, the sending sequence has so far sent all most significant digit 1's in the bit 5 row, all most significant 1's in the bit 4 row, and any data bits (X) possible for a sent most significant digit 1.

Attention is drawn to FIG. 6D, which shows the sending sequence when bit 3 is the selected significant digit.

In accordance with the twelfth operation 80 of FIG. 5, the two vertices, whose displacements had a 1 in the bit 4 row, have been added to the vertex sending list 94. The vertex sending list therefore contains the vertices 36 whose displacements show a 1 in the bit 5 row and the bit 4 row. The vertices are listed in the sequence that their displacements appear in the binary digit array 90. Also, in accordance with the thirteenth operation 82 of FIG. 5, the next lesser significant bit, bit 3, has bee selected.

In accordance with the ninth operation 74 of FIG. 5, it is to be seen that there are four 1's in the bit three row. The bit number register 88 therefore contains binary four (0000100). The sending sequence sends the contents of the bit number register 88, and then, in the sequence their displacements appear in the binary digit array 90, the identities of the four vertices 36 that have a 1 in the bit 3 row.

The sending sequence next consults the vertex sending list 94, in accordance with the eleventh operation 78 of FIG. 5. The four entries therein are for the vertices 36 whose displacements showed a 1 either on the bit 5 row or the bit 4 row. The sending sequence therefore sends the bit 3 row data bits (X), in the order they appear in the binary digit array 90, for each of the vertices 36 in the vertex sending list 94. The sending sequence then terminates 98 the bit 3 row sending stage. To this stage, then, the sending sequence has sent all most significant digit 1,s on the bit 5, bit 4, and bit 3 rows, together with any data bits (X) that appear in the bit 4 row or the bit 3 row, and in the order that they appear in the binary digit array so that they may correctly be reassembled by virtue of their implicit ordering.

Attention is drawn to FIG. 6E, showing the sending sequence with bit 2 as the selected significant bit.

In accordance with the twelfth operation 80 of FIG. 5, the vertices 36, which exhibited a 1 in the bit 3 row of their displacements in the binary digit array 90, have been added to the vertex sending register 94. In accordance with the thirteenth operation 82 of FIG. 5, the next lesser significant bit, bit 2, has become the selected significant bit.

It is to be observed that there are seven 1's in the bit 2 row. The number in the bit number register is, accordingly, binary seven (0000111). In accordance with the ninth operation 74 of FIG. 5, the sending sequence sends this number. The sending sequence next sends, as shown in the tenth operation 76 of FIG. 5, and in the order that their displacements appear in the binary digit array, the vertex 36 identities stored in the vertex address register 92. The sending sequence next, in accordance with the eleventh operation 78 of FIG. 5, consults the vertex sending list 94. There are eight entries, one for each vertex whose displacement exhibited a 1 in the bit 5, bit 4 or bit 3 row. The sending sequence sends, in the order they appear in the binary digit array 90, the bit 2 row data bits (X) for the vertices 36 in the vertex sending list 94. The sending sequence for the bit 2 row then terminates 98. Thus far, then, the sending sequence has sent all most significant digit 1's in the bit 5, bit 4, bit 3 and bit 2 rows, together with all data bits (X) in the bit 4, bit 3 and bit 2 rows.

Attention is drawn to FIG. 6F, showing how the sending sequence proceeds in the bit 1 row, where, just for the sake of the example, there is no most significant digit 1.

In accordance with the ninth operation 74, the sending sequence counts the number of 1's in the bit 1 row. Since there are none, the bit number register 88 contains binary zero, namely 0000000. This is sent. Since there are no new vertices 36 with a most significant digit in the bit 1 row, no access is made to the vertex address register. Instead, the sending sequence goes straight to the binary digit array 90 and sends all data bits (X) in the bit 1 row for those vertices 36 in the vertex sending list. This terminates the bit 1 part of the sending sequence. For bit 1, there will be no entry to be made in the vertex sending list as bit 0 is selected.

The operation carries on for bit 0 as for all of the other bits.

Attention is now drawn to FIG. 7, showing a schematic diagram of the environment in which the present invention can be used.

A sending device 100 comprises a mesh generator 102 which generates the wire mesh representations of the three dimensional final objects 14, 38. The wire mesh generation includes, in the information it provides, all of the vertices 36 in the final object, all of the hull initial vertices 12 and their absolute spatial positions, and all of the displacements of all of the vertices resulting from the division routine to re-create the final object 14, 38. The mesh generator feeds its information to a sending encoder 104 which behaves as described above in relation to FIGS. 3, 4, 5 and 6.

The sending encoder sends its stream of data to a data compressor 106. For preference, the data compressor is an Arithmetic Coding Data Compressor, as earlier mentioned and as described in “Arithmetic Coding for Data Compression” by Whitten, Neal & Cleary, Communications of the ACM, June 1987, volume 30, Number 6, pages 520 to 540, which is incorporated in this document by reference. This technique generates an ever changing minimal length coding which tracks information content to keep the coding minimal for changing content. A receiver, using the same method, can autonomously track the changing transmission codes to keep up with the transmission. Other forms of data compression can be employed.

Finally, the output of the data compressor is sent to a transmission device 108. If the sending device 100 is part of the Internet, the transmission device 108 will be connected to the Internet. If the sending device is for mobile telephones, the transmission device 108 will be connected to the mobile telephone network. Other areas of application can be used, namely any area of application where it is required to send a wire mesh representation of a three dimensional object to another device.

A reception device 110 comprises a receiver 112 which receives the signal from the transmission device 108 and demodulates it. The signal from the receiver 112 is passed to a data de-compressor 114 which recovers the signals sent from the sending encoder 104. These are sent to a mesh re-creator 116 which, using the signals from the sending encoder, regenerates the mesh. The re-generated mesh is sent to an image controller 118 which modifies the re-generated mesh, according to further instructions from the sending device 100, to display the three dimensional object (which can be swung and scaled by swinging and moving the hull), for example, on a computer monitor 120 or the screen 122 on a mobile telephone or a Personal Digital Assistant (PDA). Another area of use for the present invention is that of compact storage and recovery of images from digital storage media such as ROMs and PROMs, magnetic tapes, hard and floppy magnetic discs, CDs, DVDs etc.

The mesh generator 102 uses a particular division method for which it is programmed. The mesh re-creator 116 uses a program which operates on the same division method. At start of transmission, the sending device 100 can interrogate the reception device 110 to see if the required program is available. If it is not, the sending device 100 can send the required program to the reception device 110 for use in the mesh re-creator 116. Alternatively, the mesh generator can have, at its disposal, a plurality of different division methods. The sending device 100 can check to see which program is available in the reception device 110, and use the appropriate division method. Alternatively, again, the reception device 110 can inform the sending device which method to use, and the sending device can use it.

The mesh re-generator 116 continues with the mesh re-generation even if some of the displacement details are missing. There may have been a break in transmission, or interference. Alternatively, there may be no need to go beyond a certain degree of surface definition of the final object 14, 28 in a certain application. Because the displacement data are transmitted with the greatest displacements first, progressing down to ever smaller displacement, the effect of truncating a transmission (or deliberately abbreviating the transmission) is simply to lose finer detail. The result is that some of the vertices 36, which, if a full transmission had been sent, would have received small displacements, in fact receive no displacements. Other vertices 36 do not receive all of the binary digits which define their displacement. However, they do receive the displacement defined most significant bits first, so that only smaller adjustments are lost. The effect can be likened to focussing a lens. The longer the transmission lasts, the better the resolution of the image. Even if not perfectly focussed, however, the image is still entire, though, perhaps, lacking some resolution.

1. An apparatus for transmission of vertex position and displacement information for use in reconstructing a three dimensional surface by a surface subdivision process; said apparatus comprising; means to define co-ordinates of vertices In terms of their individual occurrence in the surface subdivision process; and means to transmit all more significant elements of the displacements before all lesser significance elements of the displacements.

2. An apparatus, according to claim 1, wherein said displacements are defined as binary numbers, and wherein said more significant elements are binary digits of greater significance, and further comprising: means to select said displacements in descending order of magnitude; means to select each significant binary digit, used to represent the displacements, in descending order of significance; means to send, in order of magnitude of the respective displacements, the total number and the co-ordinates of each a vertex whose displacement has a most significant digit equal to the selected binary digit; and means to send the selected significant bits in the representation of the displacements, in descending order of the magnitude of the respective displacement, for each vertex which has previously been found to have a most significant digit equal to a previously selected significant binary digit.

3. (canceled)

4. An apparatus, according to claim 1, wherein said means to transmit comprises means to compress data utilising Arithmetic Coding data compression means.

5. An apparatus, according to claim 2, wherein said means to transmit comprises means to compress data utilising Arithmetic Coding data compression.

6. An apparatus, according to claim 1, comprising means to encode a SPHIT Tree, said SPHIT tree being characterised by being applied to a three dimensional object.

7. An apparatus, according to any one of claims 2, 4 and 5 comprising means to encode a SPHIT Tree, said SPHIT tree being characterised by being applied to a three dimensional object.

8. An apparatus, according to any one of claims 1, 2, and 4-6 comprising means to encode a SPHIT Tree, said SPHIT Tree being characterised by the absence of sign from each indication of displacement.

9. An apparatus for reception and reconstruction of a three dimensional image, said apparatus comprising: means to receive vertex position and displacement Information for use in reconstructing a three dimensional surface by a surface subdivision process; means to receive a definition of co-ordinates of vertices in terms of their individual occurrence In the surface subdivision process; and means to receive all more significant elements of the displacements before all lesser significant elements of the displacements.

10. An apparatus, according to claim 9, wherein said displacements are defined as binary numbers, and wherein said more significant elements are binary digits of greater significance and further comprising: means to receive, in order of magnitude of the respective displacements, the total number and the co-ordinates of each vertex whose displacement has a most significant digit equal to a selected binary digit, where said displacements have been selected, for transmission in descending order of magnitude and where each significant binary digit, used to represent the displacements, has been selected, for transmission, in descending order of significance; and means to receive the selected significant bits in the representation of the displacement, in descending order of the magnitude of the respective displacement, for each vertex which has previously been found to have a most significant digit equal to a previously selected significant binary digit.

11. (canceled)

12. An apparatus, according to claim 9 wherein said means to receive comprises means to decompress data utilising Arithmetic Coding data compression.

13. An apparatus, according to claim 10, wherein said means to receive comprises means to decompress data utilising Arithmetic Coding data compression.

14. An apparatus, according to claim 9, comprising means to encode a SPHIT Tree, said SPHIT tree being characterised by being applied to a three dimensional object.

15. An apparatus, according to any one of the claims 10, 12 and 13, comprising means to decode a SPHIT Tree, said SPHIT tree being characterised by being applied to a three dimensional object.

16. An apparatus, according to any one of claims 9 10, and 12-14 including means to decode a SPHIT Tree, said SPHIT tree being characterised by the absence of indication of sign with each displacement.

17. A method for transmission of vertex position and displacement information for use In reconstructing a three dimensional surface by a surface subdivision process, said method including the steps of: defining co-ordinates of vertices in terms of their individual occurrence in the surface subdivision process; and transmitting all more significant elements of the displacements before all lesser significant elements of the displacements.

18. A method, according to claim 17, comprising the steps of: defining said displacements as binary numbers; providing that more significant elements are binary digits of greater significance; selecting said displacements in descending order of magnitude; selecting each significant binary digit, used to represent the displacements, in descending order of significance; sending, in order of magnitude of the respective displacements, the total number and the co ordinates of each vertex whose displacement has a most significant digit equal to the selected binary digit; and sending the selected significant bits in the representation of the displacement, in descending order of the magnitude of the respective displacement, for each vertex which has previously been found to have a most significant digit equal to a previously selected significant binary digit.

19. (canceled)

20. A method, according to claim 17, comprising the step of employing data compression for transmitted data which employs means suitable for use with Arithmetic Coding data compression.

21. A method, according to claim 18, comprising the step of employing data compression for transmitted data which employment of data compression comprises employing means suitable for use with Arithmetic Coding data compression.

22. A method, according to claim 17, comprising the step of encoding a SPHIT Tree, said SPHIT Tree being characterised by being applied to a three dimensional object.

23. A method, according to any one of claims 18, 20 and 21, comprising the step of encoding a SPHIT Tree, said SPHIT Tree being characterised by being applied to a three dimensional object.

24. A method, according to any one of claims 17, 18 and 20 to 22, comprising the step of encoding a SPHIT Tree, said SPHIT Tree being characterised by absence of indication of sign with each displacement.

25. A method for reception and reconstruction of a three dimensional image, said method comprising the steps of: receiving vertex position and displacement information for use in reconstructing a three dimensional surface by a surface subdivision process; receiving definition of the co-ordinates of vertices in terms of their individual occurrence in the surface subdivision process; and receiving and applying all more significant elements of the displacements before all lesser significant elements of the displacements.

26. A method, according to claim 25, comprising including the steps of: receiving definition of said displacements as binary numbers; providing that more significant elements are binary digits of greater significance; receiving, in order of magnitude of the respective displacements, the total number and the coordinates of each vertex whose displacement has a most significant digit equal to a selected binary digit, where said displacements have been selected, for transmission in descending order of magnitude and where each significant binary digit, used to represent the displacements, has been selected, for transmission, in descending order of significance; and receiving the selected significant bits in the representation of the displacement, in descending order of the magnitude of the respective displacement for each vertex which has previously been found to have a most significant digit equal to a previously selected significant binary digit.

27. (canceled)

28. A method, according to any one of claims 25 to 27, including claim 25 comprising the step of employing data decompression for received data said employment of data decompression comprising the employment of means applicable to Arithmetic Coding data compression.

29. A method, according to claim 28, comprising the step of employing data decompression for received data, wherein said employment of data decompression includes the employment of means applicable to Arithmetic Coding data compression.

30. A method, according to claim 25, comprising the step of decoding a SPHIT Tree, said SPHIT Tree being characterised by application to a three dimensional object.

31. A method, according to any one of claims 26, 28 and 29, comprising the step of decoding a SPHIT Tree, said SPHIT Tree being characterised by application to a three dimensional object.

32. A method, according to any one of claims 25, 26 and 28 to 30, including decoding a SPHIT Tree, said SPHIT Tree being characterised by absence of indication of sign with each displacement.

33. An apparatus, according to claim 7 wherein the SPHIT Tree is characterised by the absence of sign from each indication of displacement.

34. An apparatus for transmission of vertex position and displacement information for use in reconstructing a three dimensional surface by a surface subdivision process; said apparatus comprising; means to define co-ordinates of vertices in terms of their individual occurrence In the surface subdivision process; and means to transmit all more significant elements of the displacements before all lesser significance elements of the displacements; the displacements being defined as binary numbers, and said more significant elements being binary digits of greater significance, and further comprising:
means to select said displacements in descending order of magnitude; means to select each significant binary digit, used to represent the displacements, in descending order of significance; means to send, in order of magnitude of the respective displacements, the total number and the co-ordinates of each a vertex whose displacement has a most significant digit equal to the selected binary digit and means to send the selected significant bits in the representation of the displacements, in descending order of the magnitude of the respective displacement, for each vertex which has previously been found to have a most significant digit equal to a previously selected significant binary digit, wherein any vertex can be displaced.

35. An apparatus, according to claim 15 wherein the SPHIT Tree is characterised by the absence of indication of sign with each displacement.

36. An apparatus for reception and reconstruction of a three dimensional image, said apparatus comprising: means to receive vertex position and displacement Information for use in reconstructing a three dimensional surface by a surface subdivision process; means to receive a definition of coordinates of vertices in terms of their individual occurrence in the surface subdivision process; and means to receive all more significant elements of the displacements before all lesser significant elements of the displacements, wherein said displacements are defined as binary numbers, and wherein said more significant elements are binary digits of greater significance and further comprising: means to receive, in order of magnitude of the respective displacements, the total number and the co-ordinates of each vertex whose displacement has a most significant digit equal to a selected binary digit, where said displacements have been selected, for transmission in descending order of magnitude and where each significant binary digit, used to represent the displacements, has been selected, for transmission, in descending order of significance; and means to receive the selected significant bits in the representation of the displacement, in descending order of the magnitude of the respective displacement, for each vertex which has previously been found to have a most significant digit equal to a previously selected significant binary digit, wherein any vertex can be displaced.

37. An apparatus, according to claim 23, wherein said SPHIT Tree is characterised by absence of indication of sign with each displacement.

38. A method for reception and reconstruction of a three dimensional image, said method comprising the steps of: receiving vertex position and displacement information for use in reconstructing a three dimensional surface by a surface subdivision process; receiving definition of the co-ordinates of vertices in terms of their individual occurrence in the surface subdivision process; and receiving and applying all more significant elements of the displacements before all lesser significant elements of the displacements comprising including the steps of: receiving definition of said displacements as binary numbers; providing that more significant elements are binary digits of greater significance; receiving, in order of magnitude of the respective displacements, the total number and the co-ordinates of each vertex whose displacement has a most significant digit equal to a selected binary digit, where said displacements have been selected, for transmission in descending order of magnitude and where each significant binary digit, used to represent the displacements, has been selected, for transmission, in descending order of significance; and receiving the selected significant bits in the representation of the displacement, in descending order of the magnitude of the respective displacement, for each vertex which has previously been found to have a most significant digit equal to a previously selected significant binary digit, wherein any vertex can be displaced.

39. A method, according to claim 31, wherein said SPHIT Tee being characterised by absence of indication of sign with each displacement.

40. A method for reception and reconstruction of a three dimensional image, said method comprising the steps of: receiving vertex position and displacement information for use in reconstructing a three dimensional surface by a surface subdivision process; receiving definition of the co-ordinates of vertices in terms of their Individual occurrence in the surface subdivision process; and receiving and applying all more significant elements of the displacements before all lesser significant elements of the displacements comprising including the steps of: receiving definition of said displacements as binary numbers; providing that more significant elements are binary digits of greater significance; receiving, in order of magnitude of the respective displacements, the total number and the co-ordinates of each vertex whose displacement has a most significant digit equal to a selected binary digit, where said displacements have been selected, for transmission in descending order of magnitude and where each significant binary digit, used to represent the displacements, has been selected, for transmission, in descending order of significance; and receiving the selected significant bits in the representation of the displacement, in descending order of the magnitude of the respective displacement, for each vertex which has previously been found to have a most significant digit equal to a previously selected significant binary digit, wherein any vertex can be displaced.
